(19) United States
(12) Patent Application Publication
(10) Pub. No.: US 2011/0050395 A1
(43) Pub. Date: Mar. 3, 2011

(54) UTILITY MONITORING SYSTEM

(76) Inventor: Ronald G. Ervin, Encino, CA (US)

(21) Appl. No.: 12/900,447

(22) Filed: Oct. 7, 2010

Related U.S. Application Data
(60) Provisional application No. 61/249,987, filed on Oct. 8, 2009.

(51) Int. Cl. G08B 5/22; G01M 3/26

(52) U.S. Cl. 340/6.11; 702/51

(57) ABSTRACT

A utility monitoring system, methods of implementation, and programs are disclosed which can provide real-time information regarding a utility system, such as a water system of a home or building. The monitoring system can detect operating parameters or attributes of one or more sources in the water system and create a user-defined output selected so as to motivate and inspire conservation. For example, the system can output a monetized analysis of the usage of the water system. Further, the system can be configured to provide alarms in response to possible leaks when no period of zero usage is detected and/or in response to operating parameters that exceed a predetermined range of acceptable values. The system can control one or more of the sources in response to an alarm, allowing the system to shutoff or otherwise control the sources in the water system.

### CROSS-REFERENCE TO RELATED APPLICATIONS

This application claims the benefit of U.S. Provisional Application No. 61/249,987, filed Oct. 8, 2009, the entirety of which is incorporated herein by reference.

### BACKGROUND

1. Field of the Inventions

The present inventions relate to water consumption monitoring systems.

2. Description of the Related Art

Water management is a major concern throughout the world. Droughts can last for extended periods, from months to years. With water management extending from the household to the international level there are many methods employed to be proactive such as this device to manage and alleviate this problem.

For example, many cities and countries are implementing systems to preserve and conserve potable and nonpotable water supplies. For individual households and businesses, water meters have been developed which can be read at any time to determine water consumption. However, utility companies worldwide make it difficult to monitor meters since they tend to be remotely located underground in a box, which currently makes it quite difficult to monitor water consumption on a regular basis.

Accordingly, it is a difficult task for consumers to monitor and adjust their consumption since they are unaware of their daily consumption and have limited ability to monitor it. For example, in some parts of the world, consumers can wait for up to two months (a billing period) to obtain and or view an invoice to see if they made a difference or if they had a consumption problem.

### SUMMARY

Water conservation management includes water consumption, specifically to and including industrial, commercial, and household water consumption by means of monitoring and controlling water usage and detecting problems. There is a dire need for a system and methods of the type described herein to alleviate the waste of water throughout the world.

In fact, in 2001 insurance companies nationwide paid approximately $5.66 Billion in claims due to water damage caused by leaky pipes. According to statistics, 69 million homes are losing an average of 25 gallons of water a day through leaky pipes, which equates to 1.72 million gallons of water daily nationwide. This equals 627,800,000 million gallons of water wasted annually through leaky pipes.

Most persons are not engineers, let alone process engineers. The terms, “standard cubic feet per hour” or “gallons per minute” do not have a great impact upon one's sensibilities. Thus, some embodiments disclosed herein reflect the realization that to make conservation work, to make valid assumptions, flow can be converted to monetary units typically based on published water rates for that community. Accordingly, some embodiments provide a monitor that shows consumption in terms of the water bill, both in real time and historical. While there may be small rounding errors as long as the billing period is the same (initially entered during setup), the values displayed should be quite close to the actual amounts billed. In some embodiments, the consumer can determine the amount they desire to pay, and the device can inform them of how much water they can consume to meet the monthly goals. The consumer can dictate his or her own usage to meet those goals.

Thus, some embodiments provide a device that could aid the consumer with first hand knowledge and bring awareness not only to their daily consumption. Further, some embodiments can provide notice of leaks. Currently, consumers are unaware of leaks and daily consumption, so they are unable to make an immediate adjustment or immediately solve a leakage problem. Under many current systems, consumers are unable to be proactive in an environmental or financial capacity since they lack the knowledge to do so.

Accordingly, in some embodiments, the system can provide leak detection monitoring. For example, the system can determine whether a leak exists by monitoring usage. The current and/or historic usage can be analyzed to determine whether the system experiences a period when usage is zero (“zero-time”). In general, a zero-time should exist for many residential and business or industrial applications. However, a zero-time detection method may be limited in business and industrial settings. In such a system, an alarm can be triggered to indicate the presence of a possible leak. The alarm can be in several stages, from precautionary to all out alert.

Further, in some embodiments, the system can be configured to allow installation by a competent plumber on premises. The system can be configured independently of a utility company such that the system does not require input from the utility to monitor usage and make independent measurements. The system can also monitor water supplies other than from the utility company, such as harvested rainwater, graywater recycling, etc. For example, the cost of utility-provided water can be monetized and offset by the savings provided by alternative water sources.

The system can comprise equipment for harvesting water. For example, graywater and/or rainwater equipment and vessels can be used.

Further, the system can comprise one or more sensors or instruments to convey information regarding the water characteristics, such as water quality, flow rate, temperature, pressure, quantity or level, etc. For example, the system can use a level transmitter, a flow meter, and/or other instrumentation. The sensors or instruments of the system can be used on system equipment. These sensors and instruments can be used on vessels or equipment of different sizes. Further, in some cases, the temperature of the water or pressure at the main or sub meters will be useful.

Accordingly, in some embodiments, a system is provided for monitoring one or more operating parameters and attributes of a water system. The system can comprise one or more sensors and a processing unit. The one or more sensors can be in communication with one or more respective sources in the water system for detecting an operating parameter or attribute of the source. The processing unit can be operative to receive an input from the one or more sensors in real-time. The processing unit can be operative to provide an output being representative of the input received from the one or more sensors. The output of the processing unit can comprise a value-unit usage component. The processing unit can further be operative to compare the input received from the one or more sensors to detect the possibility of a leak in the water system and thereby generate a leak alarm.

Further, a leak alarm can be generated by the processing unit when the water system fails to undergo a phase of zero usage during a predetermined period, the presence of a phase of zero usage being indicative of no leaks in the system whereas the absence of a phase of zero usage indicates the possibility of a leak in the water system. Furthermore, one or more of the sensors can provide an input to the processing unit that is representative of an operating parameter or attribute of a stored water system. The processing unit can further be operative to adjust the value-unit usage component in response to the operating parameter or attribute of the stored water system.

In some embodiments, the stored water system can comprise a graywater system or a rainwater harvesting system. The value-unit usage component can comprise a monetized representation of usage of the water system. For example, the processing unit of the monitoring system can subtract a monetized value of the stored water system based on the operating parameter or attribute of the stored water system from the value-unit usage component to provide an adjusted value-unit usage component.

The output of the processing unit can further comprise a measurement-unit component. For example, the measurement-unit component can comprise usage of the water system measured in units of volume, flow rate, temperature, pressure, or water level.

In accordance with some embodiments, methods are provided for monitoring a utility system. For example, water consumption in a water system can be monitored in a method that comprises: detecting an operating parameter or attribute of one or more sources in the water system; processing a real-time value-unit usage component being representative of the operating parameter or attribute of the one or more sources, the value-unit usage component comprising a monetized representation of usage of the water system; detecting an operating parameter or attribute of a stored water system of the water system; adjusting the value-unit usage component in response to the operating parameter or attribute of a stored water system to provide an adjusted value-unit usage component; monitoring whether a usage of the system undergoes a phase of zero usage during a predetermined period; and generating a leak alarm in response to an absence of a phase of zero usage in the water system during the predetermined period.

In some embodiments, the water system can comprise a home plumbing system and stored water system. The stored water system can comprise a graywater system or a rainwater harvesting system. The value-unit usage component can comprise a monetized representation of usage of the water system. Further, the method can be configured such that the processing unit subtracts a monetized value of the stored water system based on the operating parameter or attribute of the stored water system from the value-unit usage component to provide an adjusted value-unit usage component.

The method can also be configured to further comprise displaying the value-unit usage component or the adjusted value-unit usage component on a display device. The display device can be a hardware panel. For example, the hardware panel can be installed in a home or building in which the monitoring system is active. The method can further comprise displaying a measurement-unit component of the water system. The measurement-unit component can comprise usage of the water system measured in units of volume, flow rate, temperature, pressure, or water level.

In addition, the method can comprise detecting a quality component of water in the water system. The quality component can comprise a measurement of pH, turbidity, chlorination, iron residue, heavy metal content, or oxygen reduction of the water.

The method can also be configured to comprise the step of controlling one or more sources of the system in response to an alarm. In particular, one or more sources can be shut off in response to an alarm. Otherwise, the utility characteristics, such as water flow, pressure, power, temperature, and the like can be adjusted in response to an alarm. In some implementations, the alarm can be a leak alarm.

Furthermore, in some embodiments, a computer storage medium having computer-readable instructions stored thereon which, when executed by a computer device, cause the computer device to complete a method as discussed above. For example, the computer can: detect an operating parameter or attribute of one or more sources in the water system; process a real-time value-unit usage component being representative of the operating parameter or attribute of the one or more sources, the value-unit usage component comprising a monetized representation of usage of the water system; detect an operating parameter or attribute of a stored water system of the water system; adjust the value-unit usage component in response to the operating parameter or attribute of a stored water system to provide an adjusted value-unit usage component; monitor whether a usage of the system undergoes a phase of zero usage during a predetermined period; and generate a leak alarm in response to an absence of a phase of zero usage in the water system during the predetermined period. Additional aspects of a method, as discussed herein, can also be completed by the computer device.

### BRIEF DESCRIPTION OF THE DRAWINGS

Various features of illustrative embodiments of the inventions are described below with reference to the drawings. The illustrated embodiments are intended to illustrate, but not to limit, the inventions. The drawings contain the following figures:

FIG. 1 is a schematic of a water monitoring system, according to an embodiment.

FIG. 2 is a simplified schematic of a water monitoring system, according to an embodiment.

FIG. 3 is a schematic of a water monitoring system, according to an embodiment.

FIG. 4 is a representation of a water monitoring system in use with a residence, according to an embodiment.

FIG. 5 is a schematic representation of a layout of a water monitoring system, according to an embodiment.

FIG. 6 is a representation of a panel for use with the water monitor system, according to an embodiment.

### DETAILED DESCRIPTION

While the present description sets forth specific details of various embodiments, it will be appreciated that the description is illustrative only and should not be construed in any way as limiting. Additionally, it is contemplated that although particular embodiments of the present inventions may be disclosed or shown in the context of residential applications, such embodiments can be used in business and/or industrial applications. Furthermore, it is contemplated that although particular embodiments of the present inventions may be disclosed or shown in the context of water management, such embodiments can be used in management of other resources, such as electrical utilities, gas utilities, and other supplies and applications. Furthermore, various applications of such embodiments and modifications thereto, which may occur to those who are skilled in the art, are also encompassed by the general concepts described herein.

According to some embodiments, a water consumption monitoring system can be configured as a user-customizable water consumption monitoring system that can use commercially available components. The monitoring system can provide an effective rendering of outputs in terms of cost, for example, in U.S. dollars, and/or consumption, for example, in gallons, cubic feet, etc.

Some embodiments of the monitoring system can monitor many or all fixtures or components of a modern plumbing system, including (but not limited to) mains, sub meters, water detection devices (leak or flooding), pressure devices, temperature devices, water quality analysis devices, as wells as fixtures or components of water storage systems, such as nonpotable graywater and water harvesting facilities as well. As used herein, a plumbing system of a home and/or the water storage system (whether graywater and/or water harvesting equipment) can be referred to as a “water system.” Some embodiments of the monitoring system can be used for residential use, but the monitoring system can be adapted for commercial use, as well as some industrial applications.

In some embodiments, a general purpose computer can be used with commercially available hardware and off the shelf input/output using modern computing paradigms and programming using an open database structure where consumption data is stored and retrieved as needed. Further, some embodiments of the monitoring system can utilize voice activation and/or provide control of rain harvesting facilities or as inputs to a sprinkler control system. Some embodiments can provide leak detection. For example, leak detection can be determined by lack of off-time or zero-time for the monitoring system and/or usage that is greater than historical data.

Some embodiments can also utilize sensors to detect and report flooding. For example, the monitoring system can provide data regarding moisture analysis of specified environment areas. Some embodiments of the monitoring system can utilize sensors to detect and report and water quality. For example, the monitoring system can provide data regarding temperature, pressure, and water quality data, such as purity, chlorine, fluoride, pH level, Turbidity, chlorination, iron residue, heavy metal content, oxygen reduction, and the like.

Some embodiments of the monitoring system can allow remote operation and monitoring. For example, the monitoring system can interact with a transmitter or use internet connectivity through a web server. Such transmission or connectivity can be facilitated by a computer device, such as a general purpose computer. The monitoring system can send alerts via communications devices, such as email, audible voicemail alerts, visual contact via cell phone, land line, and other future communication technologies, etc., as preferred and specified by the user, if desired. In some embodiments, the monitoring system may operate to shut off water mains or other plumbing components in response to an alarm, as discussed herein.

Some embodiments of the monitoring system can display usage in a variety of formats and units. For example, the usage can be shown in measurement units, such as gallon, hundred cubic feet (HCF), and cubic feet. However, in some embodiments, usage is shown in terms of a value unit having special significance to the customer. In some embodiments, the unit of value or value unit might represent a monetary unit. For example, monetary units (such as dollars and other currency) may be sufficient to motivate a user to achieve a desired usage goal. However, the unit of value may also be representative of a reward for achieving a target usage, such as a car, vacation, etc. which represents a tangible and meaningful goal for the user. Thus, the monitoring system can be configured to display a user-defined unit that can serve as a motivation tool for the user to achieve a desired usage goal. Accordingly, the monitoring system can display usage in terms of measurement units (i.e., gallons), monetary units (i.e., dollars), and/or value units (i.e., a car). In some embodiments, the display can show daily, weekly, annual, and previous year consumption and/or figures. Further, in some embodiments, the display can show historic as well as current and projected actual, average, and goals or targets.

In some embodiments, the monitoring system can show pressure inside the home versus pressure for outside irrigation. Further, some embodiments can be configured to provide an analysis of water quality, including various characteristics and attributes of the water.

Embodiments of the monitoring system can be user-friendly. Embodiments can be configured according to user-defined parameters and variables, such as layout and equipment. Some embodiments can allow a user to select or define target parameters that can be monitored, which can also serve as alerts or summary reports to the user. Thus, the monitoring system can facilitate water conservation, problem detection, and reduce costs to the customer.

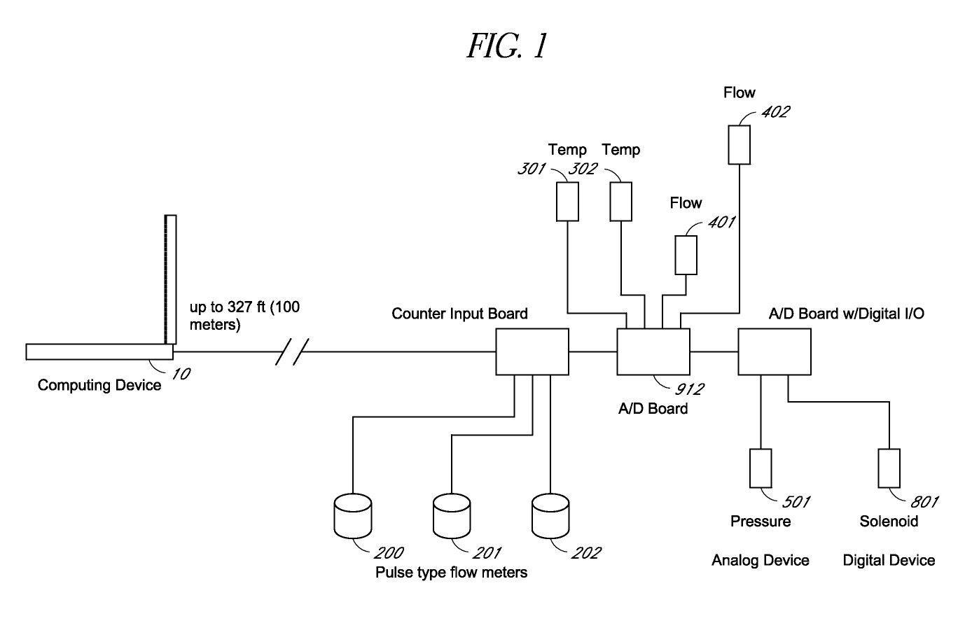

FIG. 1 is a diagram of a monitoring system in accordance with an embodiment. The monitoring system can comprise a general computing device 10, such as a personal home computing device, personal electronics, security or management computer systems, an on-board system computer, or other electronics or computer devices, whether currently or prospectively available. The computing device 10 can receive data representative of the inputs of the components of the monitoring system and can provide an output to the user.

For example, the computing device 10 can include wireless communication equipment to transmit information to one of a variety of output devices, such as displays, emails, voice messages, and the like, whether currently or prospectively available. In some embodiments, a customer interface can be available through a web server. Thus, a utility company can provide internet or remote access to customer information for a given residence or other building. The internet or remote access capability can supplement or eliminate the need for an on-site display or output interface. Further, a user or customer can input user-defined parameters, usage targets, motivators, and the like via remote access and operation.

The monitoring system can also allow a user to enter a desired range of targets or values corresponding to various detected parameters. These parameters can include, but are not limited to, usage, water quality, temperature, pressure, and the like. The monitoring system can comprise a configuration-setup that allows the user to configure the monitoring system installation. Once the user has decided what consumption level he/she desires (daily, weekly, or monthly), projected consumption above that set-point will cause the monitoring system to show the lower allowable consumption levels in order to meet the initially entered set-point. In short, due to periods of increased or decreased usage, the monitoring system can vary the daily or periodic consumption target to ensure that a broader target is met. In some embodiments, the set-point can be overridden by a reset or adjustment of the goal or target. The consumption level can be based on or tied to a measuring unit, a monetary unit, and/or a value unit.

In some embodiments, software can be written as a scan routine. A user or customer interface can be provided via a web browser and web server software. For example, the interface can access an SQL database and implement several stored routines for display of various aspects of the real time and stored data.

In some embodiments, the monitoring system can use one or more sensors or detection devices. The sensors or detection devices can be physically located on or at components or fixtures of a water system. The sensors or detection devices can physically, optically, electronically, and/or otherwise monitor flows through the water system. In some embodiments, an intelligent water meter (with a pulse/digital output) can be used. Further, an optical decoder can be used on existing meters to determine consumption.

By means of the count which is proportional to water usage, the software determines current and running averages. It will provide for a measure against a defined usage limit (set point) and provide alarming and control outputs depending upon the difference between the set point and actual and predicted usage. In the future implementations of control features will be added to improve water savings efficiency and maintenance. A full-featured monitoring system would involve multiple inputs (from multiple meters) for different zones and a coordinated control for each zone.

For example, FIG. 1 illustrates counter modules 200, 201, 202 that can be used to monitor major water sources. Water consumption can be based on pulse output (one pulse=one gallon), which can be provided by counter modules 200, 201, 202. Individual counters (not shown) can be in connectivity with a given counter module. The counters can be used at the meter and sub meter or major branch locations. The counters can be installed by a competent plumber. Further, other measurement instruments can be installed by a user knowledgeable in piping/pipefitting, particularly if PVC (or other plastic piping) is used. By means of a count of water usage, the monitoring system can determine current and running averages. The monitoring system can provide a measure against a defined usage limit (set point) and provide alarm and control outputs depending upon the difference between the set point and actual and predicted usage.

In order to monitor fluid flow of potable or non-potable water, an ultrasonic flow meter 401, 402 can be used. Typically, a flow meter can be ranged for minimum and maximum flows and output an electrical signal proportional to the flow rate. This can be received by an I/O card 912, 913 and converted to standard flow for computation. Each I/O input 912, 913 can have up to four inputs.

Additionally, the monitoring system can comprise sensors or detection devices for monitoring stored water, such as graywater and harvest vessel subsystems. In some embodiments, the monitoring of stored water could be by measuring the level in the harvest tank, as well as the outflow. For water harvesting measurements, including the acquisition of graywater, two measurements may be required for each storage facility: the liquid height and the flow rate of liquid from the facility. Using these two measurements allows computation of both inflow (height increase contrasted with outflow) and the directly measured outflow thereby establishing both consumption and storage rates. Any inflow or outflow above (or below) preset conditional rates will set a panel alarm as well as use the preferred (set by the user) method of alerting to the possible excess supply/lack of supply.

In some embodiments, the detection devices can comprise a pressure device, used to measure level or water pressure. Water pressure supplied to the monitoring system (post regulator) can be a critical measurement useful to analyze flow rates, leakage, and preventive measure for pressure overload on indoor and outdoor fixtures. A pressure device 501 can output an electrical signal proportional to the pressure between a minimum and maximum (adjustable) range. This signal could go to an analog input so designated as a pressure input 501.

For example, a gage pressure transmitter can be installed in the main supply line. One or more gage pressure transmitters can also be installed at other major sub meter lines (post regulators/distribution devices) to provide pressure inputs for analysis to correctly interpret flow rates. Both maximum and minimum pressures can signal an alarm, as well as use the preferred (set by the user) method of alerting the user (such as those discussed above) regarding possible over/under pressurization. Mechanical relief valves can be provided in each area where over pressurization could cause an unsafe condition.

In some implementations, control features can be used to improve water savings efficiency and maintenance. Some embodiments can utilize multiple inputs (from multiple meters) for different zones and a coordinated control for each zone. For example, FIG. 1 illustrates that the monitoring system can comprise, but is not limited to, a solenoid 801 that can be used to shut off flow to a given fixture or component of the water system. The solenoid 801 is representative of a control that can be used for shutoff of a stream or water source in response to a user input or an alarm from the monitoring system. Each source or stream (main or sub meters) can be controlled and monitored for emergency shutoff by the monitoring system. The monitoring system can thus utilize a solenoid valve under electrical control, with a failsafe state of closed. For input sources or streams and all others considered essential in case of a natural (or manmade) disaster, each source or stream that is so controlled can have an electrical solenoid valve of sufficient capacity for supply and spring opposed to provide a fail condition of closed when for whatever reason the governing control signal has been eliminated through fault, connection, loss of electrical supply, or disaster. This condition is appropriate to be alarmed by a set of electrical contacts and will set a panel alarm as well as use the preferred (set by the user) method of alerting to the possible control loss.

In some embodiments, temperature transmitters 301, 302 can also be provided. For example, the monitoring system can comprise one or more thermistors, thermocouples (TC) or Resistance Temperature Detectors (RTD). Such a temperature measuring means, electrical in nature, can be used at numerous locations within the water system, particularly after energy enhancement (water heaters) to ensure water temperatures are safe, and to enter the temperature into the necessary calculations as appropriate. If a temperature is too high, the monitoring system can cause the enhancement (heating) device to be turned off, while a temperature that is too cold indicates that a line may be in danger of freezing and require either heat injection, adequate consumption, or close off and bleed. In some embodiments, the temperature condition of either too hot or too cold can set a panel alarm and alert the user by a preferred method (as discussed above, and which can be set by the user) of alerting to the possible overheat/freezing. The temperature output can be proportional to the temperature between the minimum and maximum range values and can be transmitted electrically to the analog input board (912, 913). In the event of power failure, the processor can be configured to start up after power failure and continue on where the program stopped.

Accordingly, in some embodiments, the monitoring system can receive signals providing data on a variety of sources, fixtures, and/or components of a water system. These signals can include digital (water meter pulse) signals, temperature, pressure, and flow (electronic, standard) signals for the purposes of determining consumption from utilities or custody sources (paid-for sources), graywater sources (not potable, but used for irrigation rather than sent down a sewer), and rainwater harvesting sources (from simple vessels to complex storage facilities). The monitoring system is customizable depending upon desired computing power and the number of I/O available.

For example, a monitoring system can be provided that comprises a base number of inputs or sources, such as up to 16 pulsed meter inputs (eight is standard) and 52 analog I/O devices (eight is standard) with a maximum of eight control (solenoid—four is standard) digital outputs. The analog I/O may be temperature, pressure, flow, chlorine level, fluoride and pH level, and/or any other constrained range that can be presented on a 0 to 100% scale and standardized signal.

The monitoring system can provide a consumer output or program that can present a variety of graphs and usage displays including current consumption (in terms of a given unit, such as measurement units, monetary units, and/or value units), set points, mix of graywater, rain harvested water, etc. Conservation and cost data is presented in numerous formats, such as list, bar, circle, and line graphs. The monitoring system can be programmed, for example, to provide data with hourly, daily, weekly, monthly, bimonthly, previous year usage vs. current year usage and other settings to track irrigation consumption, sewage consumption and graywater usage. The reporting functions can specify leakage, consumption, and differential between the desired (set point) and actual consumption on an hourly, daily, monthly, or weighted average can be displayed in list or graphical form.

Further, the monitoring system can calculate usage and cost profiles using current water rates and by using the costs of third party (or municipal) water supplies. The algorithm can account for saved costs due to usage of stored water, such as graywater and any rain harvesting vessels. The user can be presented with information relating to cost with and without stored water savings, predicted cost based on historical data, and information regarding the amount of conserved water utilized, location, and quality. The monitoring system can also provide alerts as to when and where efficient usage of conserved water will most impact savings. Thus, the monitoring system can provide active feedback on water consumption and consumption behaviors.

In some embodiments, the output can provide a display showing the gallons or the unit of measurement used by their utility company depending on the utility company's type of billing. An on-site visual display can be the best tool to help individuals and businesses manage their water usage and provide valuable information to save water and ultimately save money and make a positive impact on the environment.

For example, the monitoring system can utilize sufficient storage (whether local or remote) to maintain water records on a daily basis for a minimum of one year. In some embodiments, the human-machine interface can be graphical and utilize a touch screen in the standalone installation. The monitoring system can also provide printing capability, such as providing actual printing or connectivity therefore, such as by attaching a USB (Universal Serial Bus) printer. The monitoring system can also allow the user to input billing rates and billing periods. Other configuration software can be included as well.

Further, the consumer output can be remotely accessed or accessed on site. The output can also be accessible on the internet, thus enabling the consumer to monitor usage and to be notified when away from the premises. The monitoring system can also comprise a network card to provide internet connectivity. For example, a 10 MBps Ethernet output can be provided with TCP 1IP capabilities. Thus, the monitoring system can be networked or accessed via the internet for true remote capabilities. Password protection and standard security practices will be employed.

The output can give the consumer a projected water usage for the billing period and the projected cost of that usage. The monitoring system can immediately show consumers the cost of their water accumulative consumption. The monitoring system can be configured to merely report usage, but in some embodiments, the monitoring system can include one or more control components that can control one or more fixtures or aspects of a water monitoring system.

Further, in some embodiments, the user can input data such as taxes, surcharges, dates for meter reading by the utility company, and tiered cost structures in order to customize the output of the monitoring system and provide an accurate representation of present and future costs. Thus, forecasting imprecision due to variables such as when one's meter is read by their utility company and other utility charges the total bill can be reduced, allowing the monitoring system to track generally what consumers will see on their water bill. Thus, the monitoring system can empower the user to change consumption habits and make smart choices regarding reducing water consumption.

In some embodiments, the monitoring system can be equipped with an alert or alarm system to alert consumers by identifying specific problem areas. The alert or alarm can be triggered based on an actual leak or based on an undesired consumption trend, such as if a target or goal is not being reached. An output for the monitoring system can be installed inside a residence or business where individuals will have easy access to view the output, but can also be transferred to handheld devices, mobile phones, emails, voicemails, and the like, whether currently or prospectively available.

The alarm system can also be programmed to alert the owner of leaks and/or flooding. The monitoring system can detect the location and/or the specific problem areas (i.e.: faucets, toilets, under house plumbing, irrigation stations, main line drips, etc.). Further, the monitoring system can give the consumer information on how minute or substantial the water leakage is (drip to flood).

For example, the monitoring system can provide real-time consumption data such that a user can verify whether a zero-time is occurring with the system. Thus, the user can verify whether although a valve is closed, a flow is still detected, which would indicate a leak in the fixtures of a water system. In residential use, there are periods when no flow should be observed. When this should be so but is not, a diagnostic will alert the user as to time, place, and magnitude of flow indicating this is a possible leak. Zero-time flow leak detection can be intrinsic to the system in some embodiments. This methodology can also be employed for streams of flow. For example, a measured stream will be compared with historical data on the stream's flow. A consistent increase in flow rate (and not merely a variety of random increases) can be indicative of a leak, and thereby generate an alarm signal to the monitoring system and the user. Further, pressure sensors can also be used to detect lack of pressure in given areas or components of the water system, which can be indicative of a leak. The leak can be reported by means of an alert delivered by email, voicemail, display, and the like.

Water detectors, rain detectors, and/or moisture detectors can be provided in the monitoring system. For example, the monitoring system can use water detectors, which are activated by a substantial (potentially user-defined) level of water which would initiate the alarm system. Water detectors can be placed in various locations that would be sensitive to flooding or moisture accumulation, such as basements, walls, or other areas of a home or building. Thus, the water detectors may not monitor fluid flow in the water system of the house or building, but instead provide an alert regarding possible flooding. These detectors can recognize a preset level of liquid (set by the user based on locale) and will set a panel alarm as well as use the preferred (set by the user) method of alerting to the possible flooding.

In some embodiments, the monitoring system can also track and provide analysis on the highest consuming components of the water system. This tool can allow the user to track usage at individual components in order to analyze possible conservation strategies for given water outlets of the house or building. In this manner, a user can able determine and understand the effects and costs of certain behaviors as regarding water conservation. Further, the monitoring system can also provide an output to indicate the amount of water saved by using water storage equipment, such as graywater and rainwater harvesting systems. Measurement units and/or value units, such as monetary units, can be used to quantify the cost saved by stored water equipment, such as graywater and harvest vessel subsystems.

The monitoring system can also be configured to include one or more sensors or detection devices that can provide an analysis of water quality or purity. The monitoring system can be designed so that water purity analysis devices may be employed. For example, instrumentation can be provided to measure metrics such as pH, Turbidity, chlorination, iron residue, chlorine, fluoride, heavy metal content, oxygen reduction, and the like. The devices can transmit water quality data to the monitoring system. The monitoring system can then monitor the data and control sources or streams of the water system using shutoff controls if necessary and/or by alerting the user that certain aspect of the water quality are outside of an acceptable (user-defined) range of values. Thus, the monitoring system can monitor and alert the user as to water purity problems, and in some embodiments, provide shutoff control of impure sources or streams.

The monitoring system can also comprise inputs for an irrigation or sprinkler system. The monitoring system can be configured with sensors to monitor given sections and/or individual heads of the sprinkler system. The monitoring system can detect bad sprinkler heads based on pressure, zero-time flow, etc. The monitoring system can also provide control of the sprinkler system for on/off duty cycles of components of the sprinkler system. The monitoring system can be used in conjunction with or in lieu of a sprinkler system I/O interface.

In some embodiments, the monitoring system can have the capacity to monitor a sprinkler system (including but not limited to selective consumption both by schedule and location). The monitoring system can monitor the integrity of the sprinkler system including heads and the performance of the monitoring system as a whole. This may require additional instrumentation in the way of ground moisture detection. However, the software can be designed to include an interface for these devices. Out of range, leakage, poor sprinkler head configuration, and any out of criteria measurements will set a panel alarm as well as use the preferred (set by the user) method of alerting for sprinkler problems. Any number of configurations are available for the sprinkler source, and a set of configured options (a standard set of connections and devices) can be included and documented with the monitoring system.

The monitoring system can also respond to or be operated using voice activation and other such commands or prompts, whether currently or prospectively available (such as other types of identification or commands including electronic finger printing, eye scanning, etc.). Voice activation of commands, a logical voice activation structure, and the reading of differing consumptions and billings can be made possible by the use of public domain software in large part with several areas requiring tuning and some software efforts. A browser can be used for consumer interface to the monitoring system. In some embodiments, a custom interface can be used for configuration and setup, while the consumer input has extremely limited programming functions primarily of a read only nature.

Accordingly, the monitoring system can be user customizable to include one or more of the sensors, detection devices, and/or components disclosed herein. For example, for determination only of the billing amounts, all that is required is one pulse meter (a basic configuration). However, the monitoring system can be as elaborate as necessary (or the customer is willing to pay). Software for expansion beyond the standard monitoring system can also be provided on an “as needed” basis. The monitoring system can be relatively easy to expand, without requiring a complete rebuild to add monitoring points, remote updating, monitoring, etc. Rebuilding need only occur when the number of monitored points exceeds the standard system configuration. Remote updating in a secure manner can be available on subscription as well as third party monitoring on a temporary or permanent basis. When subscribing to remote updating, memos concerning conservation matters can be displayed on the display relating to those items of interest as found in the subscribers profile. Additional software programs can allow the user to network with like-minded persons concerning the system or any other conservation matter.

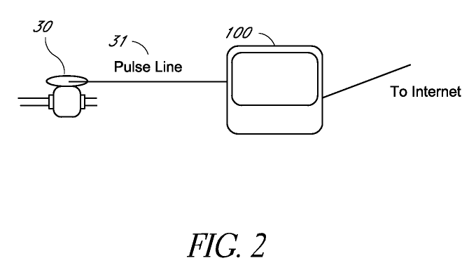

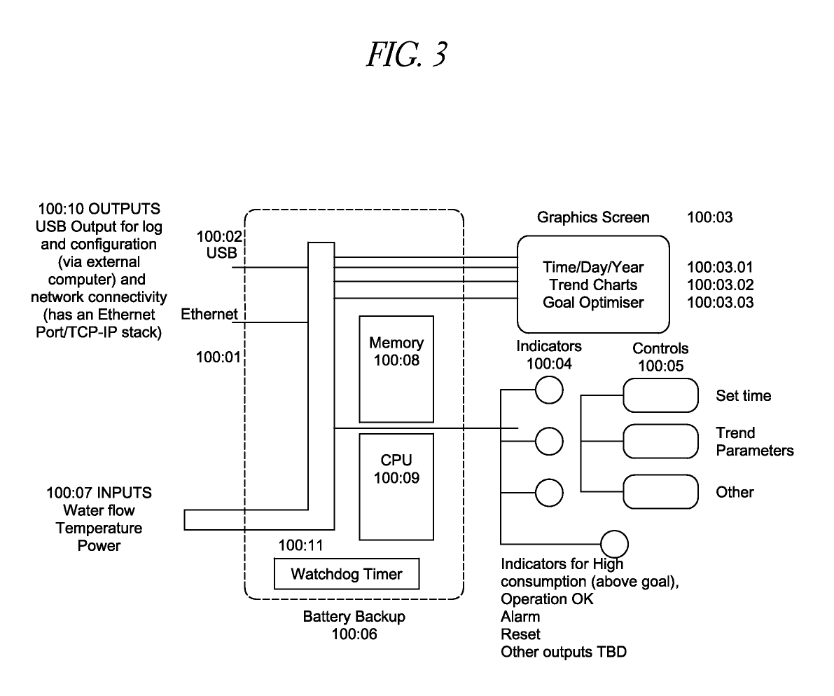

FIGS. 2-6 illustrate embodiments of a water monitoring system and its components. For example, FIG. 2 is a perspective is a water meter 30, followed by a pulse line 31 going directly to the water monitor device 100. The water monitor device 100 is in turn connected to the internet for transmitting data regarding the monitoring system. The device 100 can be a self-contained unit with a graphical interface. FIG. 3 is a detailed schematic of the water monitor device 100.

In the illustrated embodiment, the water monitor device 100 can have having a graphics screen 100:03. In some embodiments, the screen 100:03 can be a quad split screen that provides time/day/year information, trend charts, and a goal optimizer 100:03:01, 100:03:02, 100:03:03. The device 100 can have a memory 100:08, a CPU 100:09, and a timer 100:11. The outputs 100:10 would also contain indicators 100:04. The device 100 can also provide controls 100:05 that can optimize water conservation. The device 100 can also comprise a battery backup 100:06.

In some embodiments, the device 100 can comprise a USB port 100:02 and/or an Ethernet port 100:01. The inputs 100:07 could comprise any of the inputs from sensors and/or detection devices disclosed herein, such as water flow, volume, temperature, leak detection, power, water purity, and the like.

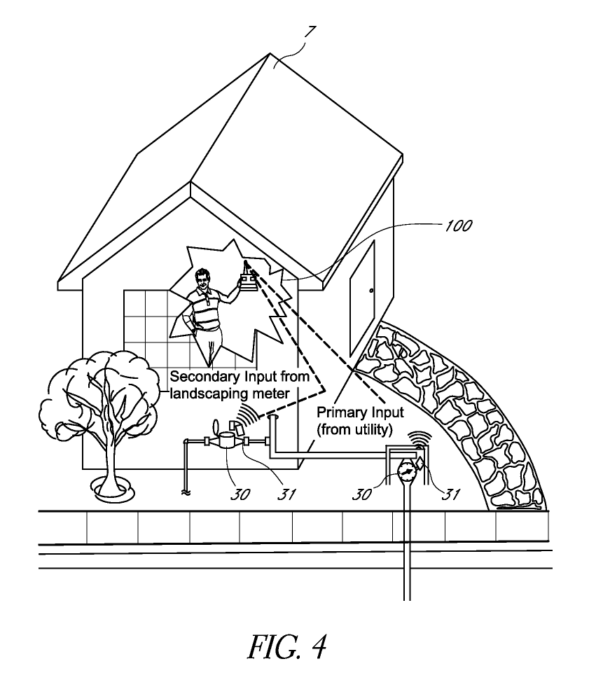

FIG. 4 is a perspective view of an embodiment of the monitoring system used in its environment of a water system. The monitoring system comprises interconnectivity with water meters 30 and pulse lines 31. The water monitor device 100 is installed in the home, with a display providing a graphical output for the user.

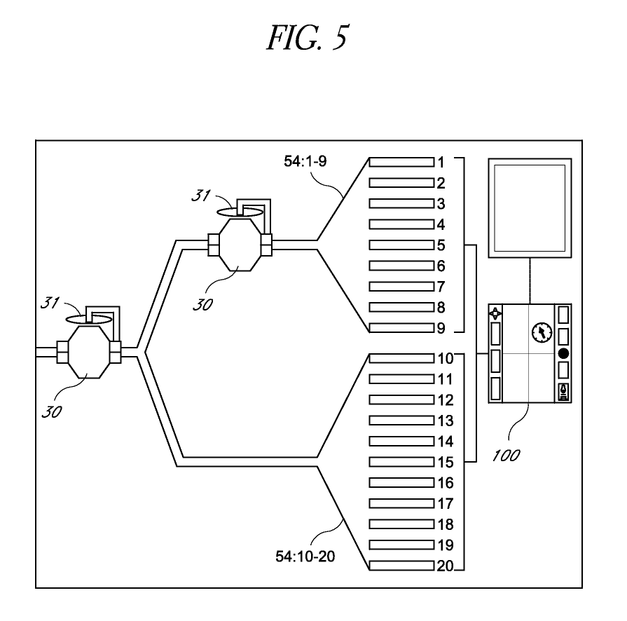

FIG. 5 is a schematic of an embodiment of the water monitoring system, utilizing a variety of optional features as sensors and detection devices. The monitoring system can comprise sensors detecting flow from the main water meter 30 and the pulse line 31. Further, Flowing to the sub meter 30 and the pulse line 31 heading to the irrigation zones 54:1-9 with zone sensors 1, 2, 3, 4, 5, 6, 7, 8, and 9. From there the information is collected and sent to the water monitor device 100 for information to be processed to conserve water and from there can be studied on the home PC 55 or office PC 56 or remotely via a transmission, such as on the internet. Water flowing to the house is represented by zones 54: 10, 11, 12, 13, 14, 15, 16, 17, 18, 19, and 20. The zones 54:1-20 represent individual and/or collective sensors and detection devices that monitor fixtures or components of the water system. As discussed above with respect to FIG. 1 (the disclosure of which is not repeated herein for sake of brevity), information is collected and sent to the water monitor device 100 for information to be processed to conserve water and from there can be studied on the home PC 55, the office PC 56, or via a remote device, such as a remote computer, handheld device, cell phone, and/or other personal electronic devices.

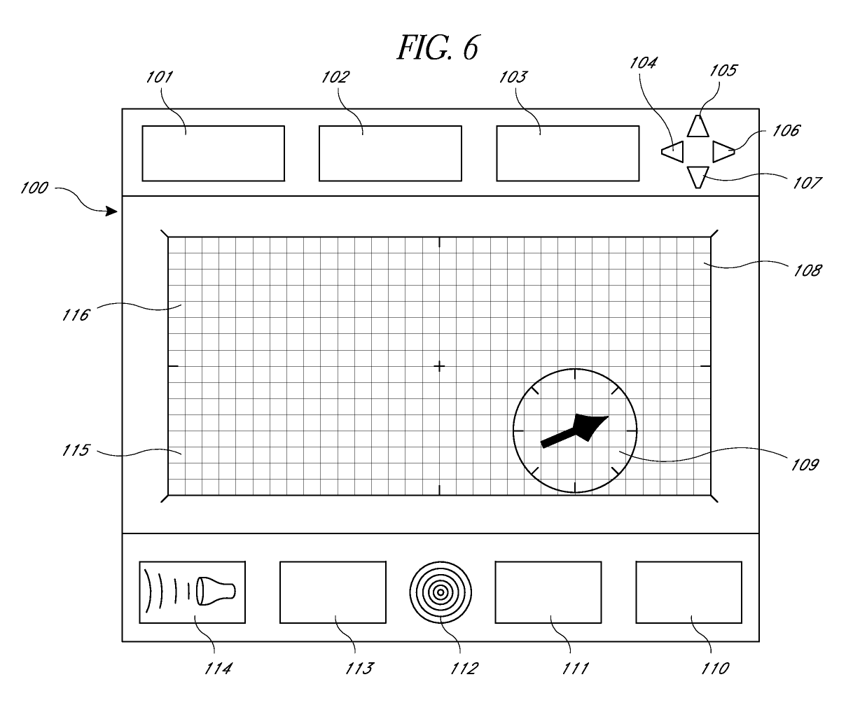

FIG. 6 is a representation of an embodiment of a panel of a water monitor device 100. As shown, the layout of the panel of the device 100 can be configured to display information on the water consumption. The operating buttons for the water monitor device 100 can comprise a Menu button 101, Programming button 102, Set button 103, Scroll left button 104, Scroll up button 105, Scroll right button 106, Scroll down button 107. The display can be a quad split, with an upper right display 108 for signal strength and digital clock. A lower right display 109 can show disk water emulator spinning when in use. In the illustration, the bottom right 109 shows gallons lost 110 and bottom right middle shows indications of problems such as leaks in certain zones 111. The bottom center indicator can be the power light 112. The bottom left middle indicator 113 can provide an indication of another parameter or measurement or value unit. The bottom left indicator can show an alarm light 114 indicating a problem. Quad split lower left display 115 can also be used for displaying a given parameter or measurement or value unit. Finally, quad split upper left display 116 can provide date regarding the tier level, dollars spent per hour, day, week, month or year, and gals/HCF consumed per hour, day, week, month, or year, etc. In some embodiments, the panel can be backlit and/or provide touch screen capability. Further, as discussed above, the user interface can also be through the web interface.

In operation, the user can configure the device or monitoring system to detect any variety of the parameters and conditions discussed herein. As noted, the water monitor device can help control water consumption and detect problems. The user can, when desired, check water consumption by the minute to yearly, check problem areas, and review current dollars spent or check projected dollars for next billing period. In some embodiment, the basic functionality can enable a user to quickly: (1) Monitor water consumption by gallons or cubic feet; (2) Monitor problem areas; (3) Monitor billing daily, weekly, monthly, or yearly; (4) Monitor billing last year vs. this year; and/or (5) Monitor various water consumption stations

Although embodiments of these inventions have been disclosed in the context of certain examples, it will be understood by those skilled in the art that the present inventions extend beyond the specifically disclosed embodiments to other alternative embodiments and/or uses of the inventions and obvious modifications and equivalents thereof. In addition, while several variations of the inventions have been shown and described in detail, other modifications, which are within the scope of these inventions, will be readily apparent to those of skill in the art based upon this disclosure. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions.

The purpose of this system is to look at total water consumption, analysis of such water and provide a dollar amount (whether from the supplier, including graywater, or rainwater harvested) as well as detecting problem areas and provide a dollar amount both as a working value and a set point. A search of the literature shows a plethora of water consumption devices almost all of which fall into two categories. They are dependent upon the municipal utility and/or its water measuring (meter) device and particularly upon the customer account records to determine historical consumption or they were designed with industrial applications in mind with perhaps an application for residential use. The second set of systems are simply too expensive for residential use and the first are limited in applicability particularly when considering gray water and rain harvesting.

One of the patents closest is Smith US2004/00206405. However, the primary consideration in the Smith patent is electronic controlling to turn systems on/off and leak detection with all other auxiliary functions as additional features. This device is for property damage prevention while its main focus is leak detection. Others such as Thompson 1995/5441070 consists of timers and shutoff systems and requires far too many flow detection and control points to be economically feasible to the average homeowner. Mohri (US 20090271329 is primarily concerned with AMR readers and Hung US 20030088527 is again primarily concerned with acquiring data through computer networks. The proposed system in this application is a real time and stored data system requiring point to point connectivity. The only networking will be at the users discretion for the remote viewing of data over the internet (use of encryption, SSL, IPSEC, VPN is at the users choice and is not a concern of this system).

What is claimed is:

1. A system for monitoring one or more operating parameters and attributes of a water system, the system comprising:
one or more sensors being in communication with one or more respective sources in the water system for detecting an operating parameter or attribute of the source; and
a processing unit being operative to receive an input from the one or more sensors in real-time, the processing unit being operative to provide an output being representative of the input received from the one or more sensors, the output of the processing unit comprising a value-unit usage component, the processing unit further being operative to compare the input received from the one or more sensors to detect the possibility of a leak in the water system and thereby generate a leak alarm;
wherein a leak alarm is generated by the processing unit when the water system fails to undergo a phase of zero usage during a predetermined period, the presence of a phase of zero usage being indicative of no leaks in the system whereas the absence of a phase of zero usage indicates the possibility of a leak in the water system; and
wherein one or more of the sensors provides an input to the processing unit that is representative of an operating parameter or attribute of a stored water system, the processing unit further being operative to adjust the value-unit usage component in response to the operating parameter or attribute of the stored water system.

2. The system of claim 1, wherein the stored water system comprises a graywater system or a rainwater harvesting system.

3. The system of claim 1, wherein the value-unit usage component comprises monetized representation of usage of the water system.

4. The system of claim 3, wherein the processing unit subtracts a monetized value of the stored water system based on the operating parameter or attribute of the stored water system from the value-unit usage component to provide an adjusted value-unit usage component.

5. The system of claim 1, wherein the output of the processing unit further comprises a measurement-unit component.

6. The system of claim 1, wherein the measurement-unit component comprises usage of the water system measured in units of volume, flow rate, temperature, pressure, or water level.

7. A method for monitoring water consumption in a water system, the method comprising:
detecting an operating parameter or attribute of one or more sources in the water system;
processing a real-time value-unit usage component being representative of the operating parameter or attribute of the one or more sources, the value-unit usage component comprising a monetized representation of usage of the water system;
detecting an operating parameter or attribute of a stored water system of the water system;
adjusting the value-unit usage component in response to the operating parameter or attribute of a stored water system to provide an adjusted value-unit usage component;
monitoring whether a usage of the system undergoes a phase of zero usage during a predetermined period; and
generating a leak alarm in response to an absence of a phase of zero usage in the water system during the predetermined period.

8. The method of claim 7, wherein the water system comprises a home plumbing system and stored water system.

9. The method of claim 7, wherein the stored water system comprises a graywater system or a rainwater harvesting system.

10. The method of claim 7, wherein the value-unit usage component comprises a monetized representation of usage of the water system.

11. The method of claim 10, wherein the processing unit subtracts a monetized value of the stored water system based on the operating parameter or attribute of the stored water system from the value-unit usage component to provide an adjusted value-unit usage component.

12. The method of claim 7, further comprising displaying the value-unit usage component or the adjusted value-unit usage component on a display device.

13. The method of claim 12, wherein the display device is a hardware panel.

14. The method of claim 12, further comprising displaying a measurement-unit component of the water system.

15. The method of claim 14, wherein the measurement-unit component comprises usage of the water system measured in units of volume, flow rate, temperature, pressure, or water level.

16. The method of claim 7, further comprising detecting a quality component of water in the water system, the quality component comprising a measurement of pH, turbidity, chlorination, iron residue, heavy metal content, or oxygen reduction of the water.

17. The method of claim 7, further comprising controlling one or more sources of the system in response to an alarm.

18. The method of claim 17, wherein one or more sources is shut off in response to an alarm.

19. The method of claim 18, wherein the alarm is a leak alarm.

20. A computer storage medium having computer-readable instructions stored thereon which, when executed by a computer device, cause the computer to:
detect an operating parameter or attribute of one or more sources in the water system;
process a real-time value-unit usage component being representative of the operating parameter or attribute of the one or more sources, the value-unit usage component comprising a monetized representation of usage of the water system;
detect an operating parameter or attribute of a stored water system of the water system;
adjust the value-unit usage component in response to the operating parameter or attribute of a stored water system to provide an adjusted value-unit usage component;
monitor whether a usage of the system undergoes a phase of zero usage during a predetermined period; and
generate a leak alarm in response to an absence of a phase of zero usage in the water system during the predetermined period.
